(19) United States
(12) Patent Application Publication
(10) Pub. No.: US 2025/0303802 A1
(43) Pub. Date: Oct. 2, 2025

(54) TOROIDAL INSERT COMPRISING MULTIPLE SEGMENTS FOR A RUN-FLAT TIRE ASSEMBLY

(71) Applicant: XERTOK LC, Olivette, MO (US)

(72) Inventor: Abu ABRAHAM, Olivette, MO (US)

(73) Assignee: XERTOK LC, Olivette, MO (US)

(21) Appl. No.: 19/095,211

(22) Filed: Mar. 31, 2025

Related U.S. Application Data
(60) Provisional application No. 63/572,275, filed on Mar. 31, 2024.

(51) Int. Cl. B60C 17/06

(52) U.S. Cl. CPC B60C 17/06

(57) ABSTRACT

The present disclosure provides a toroidal insert for a run-flat tire assembly. The toroidal insert comprises at least two inner segments arranged along a circumference of a wheel to define a first annular ring. The toroidal insert further comprises at least two outer segments arranged along the circumference of the wheel to define a second annular ring. The at least two outer segments are attached to the at least two inner segments to form the toroidal insert. An inner radial surface of the toroidal insert corresponds to a width of the wheel and is variable.

### CROSS-REFERENCE TO RELATED APPLICATIONS

This Patent Application claims the benefit of U.S. Provisional Application No. 63/572,275, filed Mar. 31, 2024, the contents of which are hereby incorporated herein by reference in its entirety.

### FIELD OF THE DISCLOSURE

The present application relates generally to a toroidal insert for a run-flat tire assembly, and in particular to the toroidal insert comprising multiple segments inserted over a wheel of the run-flat tire assembly.

### BACKGROUND

Vehicles equipped with pneumatic tires are susceptible to reduced mobility when tire damage leads to a loss of air pressure between the tire and the wheel. When a tire is punctured or deflated, sidewalls of the tire may collapse at points of ground contact. If the vehicle continues to operate on the damaged tire, the structure may deteriorate rapidly, leading to irreversible damage to the wheel. To mitigate this, vehicles may incorporate systems that maintain mobility even after tire damage. These systems, known as “run-flat” systems or “run-flat” assemblies, allow continued operation despite deflation.

Run-flat systems for pneumatic tires typically employ either a rigid wheel-mounted insert or a stiffened sidewall system integrated into the tire. Stiffened sidewall systems offer advantages such as easier installation and reduced weight, making them suitable for commercial automotive applications. However, they are not ideal for heavy-duty or military use, as they can interfere with intentional low-tire-pressure operations required for traction and mobility in certain conditions. Additionally, they lack the structural rigidity needed to support heavy vehicle loads or enable extended run-flat operation.

The run-flat insert is a dedicated support structure mounted between the wheel and the tire to bear the vehicle's load in a deflated condition. Heavy-duty and military vehicles often utilize wheel-mounted internal run-flat inserts, which function as secondary, smaller-diameter tires to support the vehicle when the main tire is deflated. The inserts endure substantial radial and lateral forces, subjecting them to tensile, compressive, and shear stresses. Designing an insert system that is both easy to install and capable of withstanding these forces while ensuring safe vehicle operation, particularly in off-road and extreme environments remains a significant challenge. The military sector is a key market for run-flat inserts, as tire damage can significantly impair mobility, increasing vulnerability by making stationary or slow-moving vehicles easier targets.

Most conventional run-flat inserts are typically designed as single-piece structures, making them difficult to install over the wheel or attach to the wheel rim. Such installations often require specialized tools for insertion and securement within the tire. Moreover, the limitations in installing these single-piece inserts restrict the choice of materials, with most conventional designs relying on elastomeric materials that can be compressed or deformed to facilitate insertion. While multi-segment inserts exist, their complex designs, such as those incorporating multiple hinged sectors can complicate the assembly process, resulting in increased production times and higher manufacturing costs.

US2012111463A1 discloses an elastomeric insert for supporting a pneumatic tire of a power lift truck or a handling vehicle. The insert supports substantially the entire internal face of the pneumatic tire and has a radially internal face intended to sit atop a wheel rim that accepts the pneumatic tire. The insert comprises two annular lateral halves, preferably molded, to form cavities designed to be inflated.

U.S. Pat. No. 4,383,566A discloses a multistrip insert, comprising three strips side-by-side, for a pneumatic tire. The insert is composed of a resilient closed-cell material or materials designed to fit around the rim of a vehicle wheel within a tubeless tire. Upon deflation of the tire, the insert becomes heated and expands to fill the tire air space thus supporting the tire.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

According to embodiments of the present disclosure, a toroidal insert over a wheel of a run-flat tire assembly is provided. The toroidal insert comprises at least two inner segments arranged along a circumference of the wheel to define a first annular ring. The at least two inner segments comprise a first lateral surface; a first inner radial surface perpendicular to the first lateral surface, and abutting an outer radial surface of the wheel; and a first outer radial surface concentric to the first inner radial surface. The toroidal insert further comprises at least two outer segments arranged along the circumference of the wheel to define a second annular ring. The at least two outer segments comprise a second lateral surface; a second inner radial surface perpendicular to the second lateral surface, and abutting the outer radial surface of the wheel; and a second outer radial surface concentric to the second inner radial surface. The at least two outer segments are attached to the at least two inner segments along the first lateral surface and the second lateral surface to form the toroidal insert. The first outer radial surface and the second outer radial surface collectively define an outer radial surface of the toroidal insert and the first inner radial surface and the second inner radial surface collectively define an inner radial surface of the toroidal insert and correspond to a width of the wheel and is variable.

In yet another embodiment of the present disclosure, a toroidal insert over a wheel of a run-flat tire assembly is provided. The toroidal insert comprises at least two inner segments arranged along a circumference of the wheel to define a first annular ring. The at least two inner segments comprise a first lateral surface; a first inner radial surface perpendicular to the first lateral surface, and abutting an outer radial surface of the wheel; and a first outer radial surface concentric to the first inner radial surface. The toroidal insert further comprises at least two outer segments arranged along the circumference of the wheel to define a second annular ring. The at least two outer segments comprise a second lateral surface; a second inner radial surface perpendicular to the second lateral surface, and abutting the outer radial surface of the wheel; and a second outer radial surface concentric to the second inner radial surface. The at least two outer segments are attached to the at least two inner segments along the first lateral surface and the second lateral surface to form the toroidal insert. The first outer radial surface and the second outer radial surface collectively define an outer radial surface of the toroidal insert and the first inner radial surface and the second inner radial surface collectively define an inner radial surface of the toroidal insert and correspond to a width of the wheel and is variable. The at least two outer segments and the at least two inner segments are joined along joints, wherein the joints are staggered across the insert.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

The accompanying drawings illustrate the various embodiments of the disclosed disclosure and methods of design, manufacture, use and other aspects of the disclosure. It will be apparent to a person skilled in the art that the illustrated elements in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present disclosure are illustrated by way of example, and are not limited by the appended figures, in which like references indicate similar elements, and in which:

FIG. 1A is an exploded view of a run-flat tire assembly, according to various embodiments of the present disclosure;

FIG. 1B is a cross-sectional view of an assembled run-flat tire assembly, according to various embodiments of the present disclosure;

FIG. 2 is a sectional view of a toroidal insert, according to embodiments of the present disclosure; and

FIGS. 3A-E are cross-sectional views of various toroidal inserts, according to embodiments of the present disclosure.

### DETAILED DESCRIPTION

As used in the specification and claims, the singular forms “a”, “an” and “the” include plural references unless the context clearly dictates otherwise. For example, the term “an article” may include a plurality of articles unless the context clearly dictates otherwise.

Those with ordinary skill in the art will appreciate that the elements in the Figures are illustrated for simplicity and clarity and are not necessarily drawn to scale. For example, the dimensions of some of the elements in the Figures may be exaggerated, relative to other elements, in order to improve the understanding of the present disclosure.

In this detailed description of the present disclosure, a person skilled in the art should note that directional terms, such as “above”, “below”, “upper”, “lower”, “inner”, “outer” and other like terms are used for the convenience of the reader in reference to the drawings. Also, a person skilled in the art should notice this description may contain other terminology to convey position, orientation, and direction without departing from the principles of the present invention. The terms “first” and “second” are only used for descriptive purposes, and should not be construed as indicating or implying relative importance or implicitly indicating the number of technical features indicated. Thus, a feature defined as “first” or “second” may expressly or implicitly include one or more of that feature. In the description of this application, the term “multiple” refers to “more than one”. The term “multiple segments” when used in the context of a toroidal insert corresponds to having more than 4 segments. The term “at least two” as used herein, refers to having two or more than two.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

There may be additional components described in the foregoing application that are not depicted on one of the described drawings. In the event such a component is described, but not depicted in a drawing, the absence of such a drawing should not be considered as an omission of such design from the specification.

As required, detailed embodiments of the present disclosure are disclosed herein; however, it is to be understood that the disclosed embodiments are merely exemplary of the disclosure, which can be embodied in various forms. Therefore, specific structural and functional details disclosed herein are not to be interpreted as limiting, but merely as a basis for the claims and as a representative basis for teaching one skilled in the art to variously employ the present disclosure in virtually any appropriately detailed structure. Further, the terms and phrases used herein are not intended to be limiting but rather to provide an understandable description of the disclosure.

Embodiments of the present disclosure offer a toroidal insert comprising multiple segments for a run-flat tire assembly. The term “toroidal insert”, as used herein refers to a three-dimensional shaped body, either solid or hollow, having a top surface, a bottom surface, and side surfaces, where each of the top surface and the bottom surface has a substantially curved or rounded profile. The side surfaces extend between the top and bottom surfaces and may have any geometric configuration, including but not limited to flat, curved, or faceted shapes.

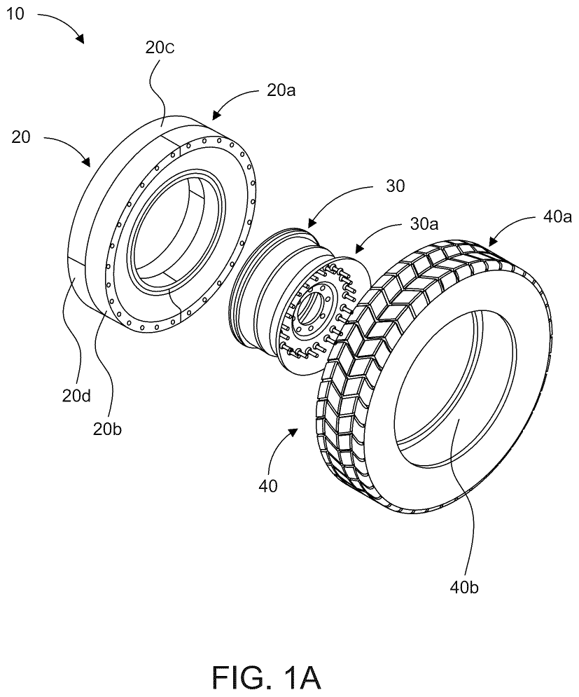

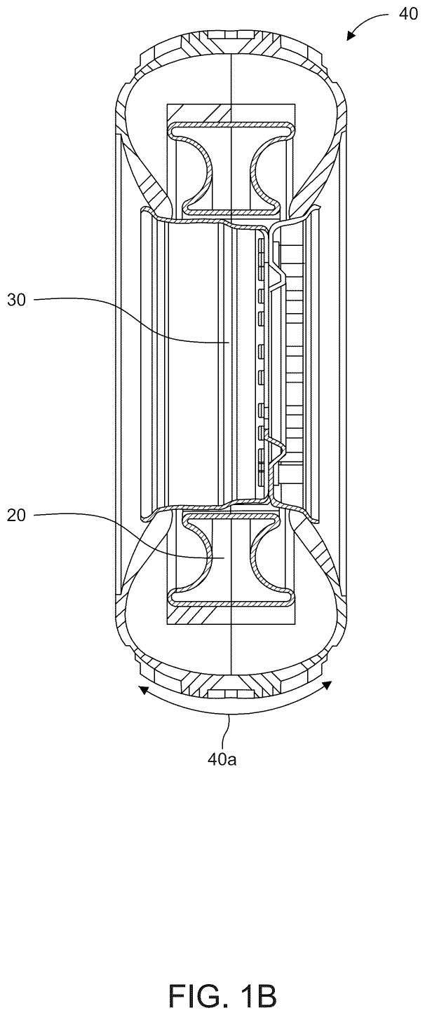

FIG. 1A is an exploded view of a run-flat tire assembly 10 according to embodiments of the present disclosure. The run-flat tire assembly 10 includes a toroidal insert 20, a wheel 30, and a tire 40.

The wheel 30 includes a wheel rim 30a, an outer edge of the wheel that holds the tire 40. Typical wheels are made from materials, such as steel, aluminum alloys, and composite materials. The wheels are designed to bear a load ranging from 1000 kilograms (kg) to 20,000 kg, and have a radius ranging from 6 inches to more than 25 inches.

The tire 40 includes a tire tread 40a that is in contact with a surface of a road. A space between an inner surface 40b of the tire 40, and the toroidal insert 20 and wheel 30 is filled with air to form a pneumatically inflated structure supported by a body of the tire 40. The tire 40 may be any commercially available tire and is made of a material, such as synthetic rubber, natural rubber, fabric, and wire, along with carbon black and other chemical compounds. The tire tread 40a provides traction. For heavy-duty vehicles and military vehicles, a width of tire tread 40a is a critical factor for the stability and safe run of these vehicles.

A particular advantage of the disclosure is the case of installation of the toroidal insert 20, as it is composed of multiple segments 20a, 20b, 20c, and 20d. Further, the installation may not require any special tools, unlike in the installation of prior art inserts. In one embodiment, during installation segments 20a, 20b, 20c, and 20d of the insert 20 are pushed into tire cavity and the tire 40 is inserted over the wheel 30 as is typically done with any other regular tires.

FIG. 1B is a cross-sectional view of the run-flat tire assembly 10 when assembled. The toroidal insert 20 abuts the wheel 30, and the tire 40 is inserted over the wheel 30.

The tire 40 supports the weight of a vehicle. In a deflated state, tire 40 loses air pressure with a resulting collapse of the pneumatically inflated structure and hence a resulting load on the wheel 30 is taken up by the insert 20.

The run-flat tire assembly may be designed for use in particular, emergency vehicles, ambulances, fire trucks, heavy-duty vehicles, military vehicles, and all-terrain vehicles. It will be appreciated that the precise form and size of the insert 20 will depend upon the particular size and type of tires with which it or they are to be used at which the run-flat assembly 10 can run without irreparable damage for a substantial time and distance. In one embodiment, the toroidal insert 20 is optimized to take a load of at least 2,000 kg per wheel, to cover a safe distance of at least 30 miles, at a speed not less than 30 miles per hour (mph), without any adverse effect. As used herein, the term “safe distance”, refers to a distance that is covered by the vehicle under run-flat conditions without any substantial damage to the wheel 30 or the vehicle.

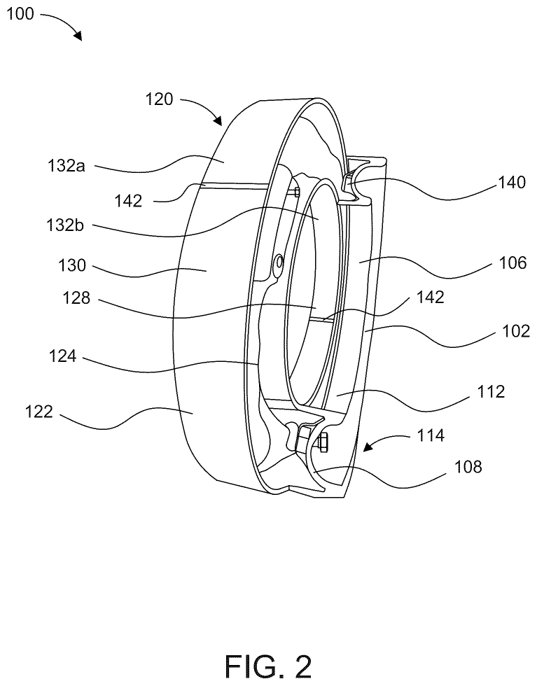

FIG. 2 is a schematic representation of a toroidal insert 100 (also referred to as insert) according to embodiments of the present disclosure. The insert 100 comprises at least two inner segments 102 arranged along a circumference of a wheel (not shown) to define a first annular ring. In FIG. 2, insert 100 is depicted as including a single inner segment 102. The at least two inner segments 102 comprise a first lateral surface 108, a first inner radial surface 112, and a first outer radial surface 114. The first inner radial surface 112 is perpendicular to the first lateral surface 108 and abuts an outer radial surface of the wheel (for example, wheel 30 of FIGS. 1A-B). The first outer radial surface 114 is concentric to the first inner radial surface 112.

The insert 100 comprises at least two outer segments 120 arranged along the circumference of the wheel (not shown) to define a second annular ring 122. The at least two outer segments 120 comprise a second lateral surface 124, a second inner radial surface 128, and a second outer radial surface 130. The second inner radial surface 128 is perpendicular to the second lateral surface 124 and abuts an outer radial surface of the wheel. The second outer radial surface 130 is concentric to the second inner radial surface 128.

The insert 100 is constructed from a material or a combination of materials having material properties to meet performance criteria of the insert 100. The performance criteria may include, but are not limited to, load-carrying capacity, ride comfort, weight of the insert 100, and cost of the insert 100. As used herein, the term “load-carrying capacity” refers to a weight supported by the insert 100 for a safe run under run-flat conditions, where the run-flat conditions may include distance to be traveled, the speed, and an ambient temperature range at which the vehicle operates. Examples of material properties may include thermal resistance, mechanical damping, impact strength, chemical stability, resilience to repeated deformation, density, flexibility, resistance to mechanical wear and tear, tensile strength, toughness, or any combination thereof.

As used herein, the term “thermal resistance” is a measure of a material's opposition to the flow of heat through it, and is typically expressed as the temperature difference across the material per unit of heat flux (° C·m²/W). The terms “thermal resistance, “thermal conductivity” and “thermal dissipation” are interconnected. The term “thermal conductivity” refers to a measure of a material's ability to conduct heat. Thermal resistance and thermal conductivity are inversely related. The term “thermal dissipation refers to a process of transferring and releasing heat from a material or system into the surrounding environment. A material with a high thermal conductivity is known to dissipate heat quickly when compared to a material with a low thermal conductivity.

As used herein, the term “mechanical damping” refers to an ability of a material to dissipate energy from mechanical vibrations, oscillations, or cyclic stresses, typically characterized by a damping ratio or loss factor. It is critical in reducing resonance and controlling vibration-induced damage.

As used herein, the term “impact strength” refers to a capacity of a material to absorb and dissipate energy during a sudden impact or high-velocity force, typically quantified using notched Izod or Charpy impact tests. It reflects the material's toughness and resistance to brittle fracture.

As used herein, the term “resilience to repeated deformation” refers to a material's capability to withstand cyclic loading and unloading without experiencing significant permanent deformation, fatigue, or failure.

As used herein, the term “density” is defined as mass per unit volume of a material expressed as kilograms per cubic meters (kg/m³) or grams per cubic meters (g/cm³). It is a fundamental property influencing material weight, mechanical strength, and performance in load-bearing applications.

As used herein, the term “flexibility” refers to an ability of a material to undergo elastic or plastic deformation under applied stress without fracture. Flexibility is often quantified through elongation at break or flexural modulus measurements.

As used herein, the term “resistance to mechanical wear and tear” refers to a material's capacity to withstand surface degradation due to friction, abrasion, erosion, or repeated mechanical contact.

As used herein, the term “tensile strength” is defined as the maximum stress a material can endure under uniaxial tensile loading before fracture occurs, typically measured in Pascals (Pa) or MegaPascals (MPa). It indicates the material's resistance to stretching forces.

As used herein, the term “toughness” refers to total energy a material can absorb before fracturing, representing a balance between strength and ductility. Toughness is typically measured as the area under the stress-strain curve in a tensile test.

As used herein, the term “chemical stability” refers to a material's ability to resist chemical changes when exposed to external conditions such as heat, light, moisture, air, or various chemicals such as acids, bases, and/or solvents. It indicates the material's resistance to degradation, oxidation, corrosion, or decomposition over time.

In one embodiment, the material of the insert 100 comprises a metal, a composite material, an elastomer, a thermoplastic, a polymer, or any combination thereof. Examples of metals include steel, stainless steel, and high-strength alloys that may provide tensile strength and resistance to mechanical wear and tear. Examples of polymers include epoxy polymers, polyolefins, polyethylene, polypropylene, polyurethane, and polyamides. Examples of elastomers include natural rubber, styrene-butadiene rubber, silicone, and urethane elastomers that may provide flexibility, mechanical damping, and resilience to repeated deformation. Examples of thermoplastics include Polyether Ether Ketone (PEEK), polycarbonate, and acrylonitrile-butadiene-styrene (ABS) which may provide impact strength, and thermal resistance. Examples of composite materials include fiber-reinforced composite materials, where a polymer resin matrix is reinforced with fibers to enhance structural performance while reducing weight. Non-limiting examples of fibers include carbon fibers, glass fibers, aramid fibers (e.g., Kevlar®), and any combinations thereof. The polymer resin of the fiber-reinforced composite material comprises epoxy, polyester, vinyl ester, phenolic resins, polyolefins, polyethylene, polyurethane, nylon, Polyether Ether Ketone (PEEK), or any combinations thereof providing chemical stability and toughness to the composite material. When compared to metals and polymers, fiber-reinforced composite materials provide enhanced thermal conductivity, and impact resistance at lighter weight making them ideal for demanding applications such as high-performance automotive, acrospace, and military environments.

In one embodiment, the insert 100 is made from carbon fiber-reinforced vinyl ester resin composite, with a tensile strength of 750 MPa (MegaPascal), and a load-carrying capacity of more than 2000 Kg. It is envisaged that the insert 100 be made of a mixture of materials, for example, each of the at least two inner segments 102, or each of the at least two outer segments 120 may compose different materials chosen from the above materials.

The at least two outer segments 120 are attached to the at least two inner segments 102 along the first lateral surface 108 and the second lateral surface 124 to define the first annular ring and the second annular ring 122 thus forming the toroidal insert 100. In one embodiment, the at least two outer segments 120 and the at least two inner segments 102 are hollow structures. In certain embodiments, the at least two outer segments 120 and the at least two inner segments 102 are solid structures. When the at least two outer segments 120 and the at least two inner segments 102 are hollow structured, the first lateral surface 108 and the second lateral surface 124 are only continuous at a point of attachment or a plane of attachment. As used herein, the terms “point of attachment” and “plane of attachment” refer to the point or plane on the first lateral surface 108 and the second lateral surface 124 at which both segments are attached. The point of attachment and/or the plane of attachment may lie anywhere on the first lateral surface 108 and the second lateral surface 124, of the at least two inner segments 102 and the at least two outer segments 120, respectively, and correspond to element 140 in FIG. 2.

The first outer radial surface 114 and the second outer radial surface 130 collectively define an outer radial surface 132a of the toroidal insert 100. The first inner radial surface 112 and the second inner radial surface 128 collectively define an inner radial surface 132b of the toroidal insert 100, and corresponds to a width of the wheel and is variable. The at least two outer segments 120 are joined to the at least two inner segments 102 to form joints 142. The joint 142, as used herein, can be considered as a plane at which both the segments, (namely, the at least the two inner segments 102 and the at least two outer segments 120) meet in a direction perpendicular to a radial axis of the insert 100, though the point of attachment 140 or plane of attachment may differ. In FIG. 2 the point of attachment 140 is adjacent to the joint 142. The joints 142 according to embodiments of the present disclosure are offset or staggered along an outer radial surface 132a and/or an inner radial surface 132b of the insert 100, or across the insert 100. Typically, in prior art multi-segment inserts, the joints between the segments often extend across a width of the insert corresponding to the width of the wheel and/or the tire thus creating stress concentration points that may compromise structural integrity and durability of the inserts.

The term “variable”, as used herein refers to changing a width of the insert 100 (corresponding to changing a width of the inner radial surface 132b) to customize it to the width of the wheel while optimizing for the performance of the insert 100. In the present disclosure, it is possible to change the width, as the insert 100 is made from multiple segments, unlike singular-piece inserts. In one embodiment, the insert 100 is made from a combination of a carbon composite material and a urethane elastomer of differing durometer wherein the inner radial surface 132b of the insert 100 is made from a softer durometer urethane elastomer for better hold of the insert 100 on the wheel while the outer radial surface 132a of the insert 100 is made from a stiffer durometer urethane elastomer to reduce friction between the insert 100 and a tire as well as to provide mechanical damping while moving over uneven road surfaces. As used herein, the term “durometer” refers to a relative measure of hardness of a material measured using a Shore Durometer and is expressed on a scale of 0 to 100. The term “stiffer durometer”, as used herein refers to a durometer value of 70, or more than 70, while the term “softer durometer” refers to a durometer value of less than 70.

A single-piece toroidal insert has limitations on its dimensions, for example, width, thickness, and radius, due to the difficulty of installing over a wheel. Typically, the width of a single-piece toroidal insert varies from 20 percent to a maximum of 60 percent compared to the width of a wheel depending on the material of the insert. A single-piece elastomeric insert may require bending and additional means or parts to fold the insert into place before installing a tire over the wheel. The toroidal insert 100 requires less effort compared to a single-piece insert as it is formed by attaching multiple segments (namely, at least two inner segments 102 and at least two outer segments 120) over the wheel.

It is a particular advantage of the disclosure, as the insert 100 is assembled from multiple segments, there is flexibility in the appropriate selection of materials, or a combination of materials according to the insert performance criteria such as load-carrying capacity while taking into account stress distribution across the insert, thermal dissipation of the insert, impact resistance, or any combination thereof.

The at least two outer segments 120 and the at least two inner segments 102 are joined along the joints 142, wherein the joints 142 are staggered across the insert 100. A staggered joint (for example 142) advantageously provides stress re-distribution across the outer radial surface 132a and/or the inner radial surface 132b of the insert 100. The staggered joints 142 result in insert 100 having a larger load-carrying capacity when compared to an insert where the joints are not staggered.

The at least two outer segments 120 and the at least two inner segments 102 are attached using mechanical fasteners, adhesives, thermal bonding, interlocking features, or any combination thereof. In one embodiment, the at least two outer segments 120 and the at least two inner segments 102 are attached using mechanical fasteners, as shown in FIG. 2 (140).

In one embodiment, a width of the outer radial surface 132a of the insert 100 is up to 100% of the width of a tire tread (for example, tire tread 40a of FIGS. 1A-B). Hence a vehicle incorporating the insert 100 has higher traction due to the larger width possible in the insert 100.

In certain embodiments, the width of the inner radial surface 132b of the insert 100 is up to 100% of the width of the wheel. The larger width of the inner radial surface 132b of the insert that matches the width of the wheel supports stress distribution and heat dissipation compared to an insert with a smaller width.

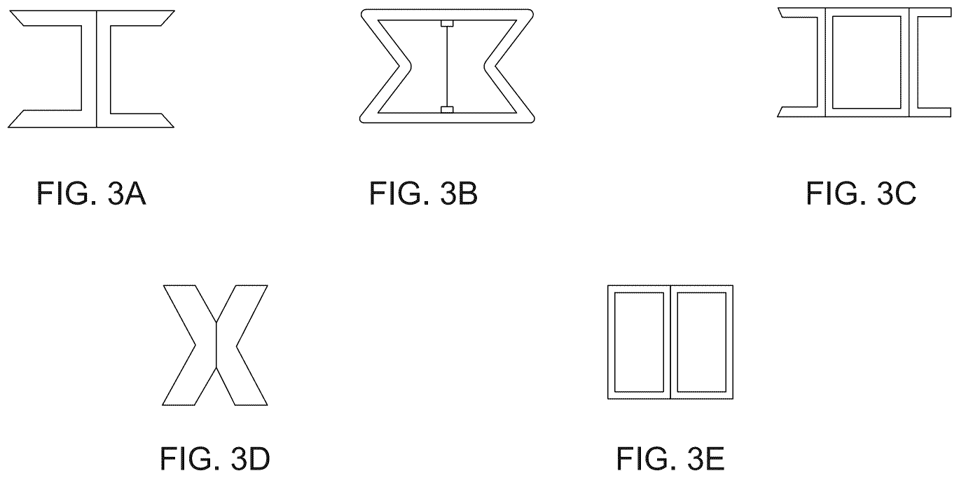

FIGS. 3A to 3E are various cross-sections of a toroidal insert (For example, insert 10, 100 of FIGS. 1-2). As will be appreciated, cross-sections of the inserts are optimized depending on the vehicle, the number of wheels present in the vehicle, load-carrying capacity of each wheel, a diameter of the wheel, safe-run conditions of the vehicle. The cross-sections of the insert are optimized for stress distribution across the segments, thermal dissipation, impact resistance, or any combination thereof while optimizing for a load-carrying capacity, weight, and cost of the insert. The optimization takes into account the material properties of the insert. As shown in FIG. 3A, the cross-section is C-shaped. The C-shaped cross-section helps in reducing a weight of the insert when compared to a solid structured insert. In FIG. 3B, the cross-section is M-shaped at a point of attachment with a corresponding segment to form the insert while an interior of the insert may be hollow. FIG. 3C shows a twin “I” beam shape which enhances load-carrying capacity of an insert. FIG. 3D shows an “X” shape that may be best suited for off-road applications. FIG. 3E shows a twin box beam shape which can be hollow or solid-structured. Accordingly, various configurations of the cross-sections may be employed.

The disclosed embodiments are illustrative and not intended to limit the possible variations. Although selected embodiments have been illustrated and described in detail, it may be understood that various substitutions and alterations are possible. Those having an ordinary skill in the art and access to the present teachings may recognize additional various substitutions and alterations are also possible without departing from the spirit and scope of the present disclosure.

What is claimed is:

1. A toroidal insert over a wheel of a run-flat tire assembly comprising:
at least two inner segments arranged along a circumference of the wheel to define a first annular ring, wherein each of the at least two inner segments comprise:
a first lateral surface;
a first inner radial surface perpendicular to the first lateral surface, and abutting an outer radial surface of the wheel; and
a first outer radial surface concentric to the first inner radial surface;
at least two outer segments arranged along the circumference of the wheel to define a second annular ring, wherein each of the at least two outer segments comprise:
a second lateral surface;
a second inner radial surface perpendicular to the second lateral surface, and abutting the outer radial surface of the wheel; and
a second outer radial surface concentric to the second inner radial surface;
wherein the at least two outer segments are attached to the at least two inner segments along the first lateral surface and the second lateral surface to form the toroidal insert, wherein the first outer radial surface and the second outer radial surface collectively define an outer radial surface of the toroidal insert, and wherein the first inner radial surface and the second inner radial surface collectively define an inner radial surface of the toroidal insert and corresponds to a width of the wheel and is variable.

2. The toroidal insert as claimed in claim 1, wherein a material of the at least two inner segments and the at least two outer segments comprise an elastomer, a composite material, a metal, a polymer, a thermoplastic, or any combinations thereof.

3. The toroidal insert as claimed in claim 2, wherein the material of the at least two inner segments and the at least two outer segments comprise the composite material.

4. The toroidal insert as claimed in claim 1, wherein a cross-section of the toroidal insert is twin I beam shaped, X-shaped, twin box beam shaped, C-shaped, M-shaped, or any combinations thereof.

5. The toroidal insert as claimed in claim 1, wherein the at least two outer segments and the at least two inner segments are attached using mechanical fasteners, adhesives, thermal bonding, interlocking features, or any combination thereof.

6. The toroidal insert as claimed in claim 1, wherein the at least two outer segments and the at least two inner segments are joined along joints, wherein the joints are staggered across the toroidal insert.

7. The toroidal insert as claimed in claim 1, wherein a width of the outer radial surface of the toroidal insert is up to 100% of a width of a tire tread.

8. The toroidal insert as claimed in claim 1, wherein a width of the inner radial surface of the insert is up to 100% of the width of the wheel.

9. A toroidal insert over a wheel of a run-flat tire assembly comprising:
at least two inner segments arranged along a circumference of the wheel to define a first annular ring, wherein each of the at least two inner segments comprise:
a first lateral surface;
a first inner radial surface perpendicular to the first lateral surface, and abutting an outer radial surface of the wheel; and
a first outer radial surface concentric to the first inner radial surface;
at least two outer segments arranged along the circumference of the wheel to define a second annular ring, wherein each of the at least two outer segments comprise:
a second lateral surface;
a second inner radial surface perpendicular to the second lateral surface, and abutting the outer radial surface of the wheel; and
a second outer radial surface concentric to the second inner radial surface;
wherein the at least two outer segments are attached to the at least two inner segments along the first lateral surface and the second lateral surface to form the toroidal insert, wherein the first outer radial surface and the second outer radial surface collectively define an outer radial surface of the toroidal insert, wherein the first inner radial surface and the second inner radial surface collectively define an inner radial surface of the toroidal insert and corresponds to a width of the wheel and is variable, wherein the at least two outer segments and the at least two inner segments are joined along joints, and wherein the joints are staggered across the toroidal insert.
